(19) United States
(12) Patent Application Publication
(10) Pub. No.: US 2025/0033533 A1
(43) Pub. Date: Jan. 30, 2025

(54) RISK SCENARIO ADAPTION

(71) Applicant: Volvo Car Corporation, Göteborg (SE)

(72) Inventors: Fredrik Heurlin, Göteborg (SE); Magnus Björklund, Göteborg (SE); Peter Adolfsson, Göteborg (SE); Katarina Bohman, Göteborg (SE); Jonas Östh, Göteborg (SE); Johan Rosenberg, Göteborg (SE); Andreas Carlsson, Göteborg (SE); Peter Setterberg, Göteborg (SE)

(73) Assignee: Volvo Car Corporation, Göteborg (SE)

(21) Appl. No.: 18/361,329

(22) Filed: Jul. 28, 2023

(51) Int. Cl. B60N 2/02; B60N 2/00; G06V 20/59

(52) U.S. Cl. CPC B60N 2/0268; B60N 2/0022; B60N 2/0025; B60N 2/0027; B60N 2/0273; B60N 2/0278; G06V 20/597; B60R 22/48; B60R 2022/4858

(57) ABSTRACT

An embodiment related to a system, wherein the system comprising an alertness detector unit configured to detect an alertness signal of an occupant an alertness determination unit configured to determine an alertness of the occupant based on the alertness signal, an environment sensing unit configured to sense external data in a route, an analysis unit configured to analyze the external data to determine an external condition, a risk assessment unit configured to determine a risk level in real-time based on an analysis of the external data and the alertness of the occupant, and a control unit configured to adjust a seat if determined that the real-time risk level was above a threshold.

### FIELD OF THE INVENTION

The present disclosure relates generally to systems for risk scenario adaption and, more particularly, to systems, algorithms, and processes for making automatic adjustments to optimize seat belt tension and car seat positioning based on situational awareness.

### BACKGROUND

Traditional car seats and seat belt systems may not fully account for the dynamic nature of driving conditions or the unique characteristics of each occupant. They lack the ability to adapt to the dynamic nature of driving conditions. They do not consider factors such as sudden accelerations, decelerations, or sharp turns, which can result in inadequate seat belt tension and compromised occupant safety. Traditional systems fail to account for the unique characteristics of individual occupants. Body sizes, postures, and preferences vary among people, and a one-size-fits-all approach may lead to discomfort, improper fit, or even injuries. Also, traditional systems provide limited feedback or reminders for proper seat belt usage, relying solely on the occupant's awareness and compliance.

Therefore, there is a need for a system and method that can overcome these limitations by dynamically adapting to driving conditions, providing personalized adjustments, and offering real-time alerts to promote optimal safety and comfort for all occupants.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

An embodiment relates to a system comprising an alertness detector unit configured to detect an alertness signal of an occupant, an alertness determination unit configured to determine an alertness of the occupant based on the alertness signal, a sensing module configured to sense external data in a route, an analysis unit configured to analyze the external data to determine an external condition, a risk assessment unit configured to determine in real-time a real-time risk level based on an analysis of the external data and the alertness of the occupant, and a control unit configured to adjust a seat if determined that the real-time risk level was above a threshold.

Another embodiment relates to a method comprising detecting an alertness signal of an occupant in a vehicle, determining an alertness of the occupant based on the alertness signal, sensing external data, determining a risk level based on an analysis of the external data and the alertness of the occupant, and adjusting a seat adjustment function of the vehicle based on the risk level.

Yet another embodiment relates to a non-transitory computer-readable medium having stored thereon instructions executable by a computer system to perform operations comprising detecting an alertness signal of an occupant in a vehicle, determining an alertness of the occupant based on the alertness signal, sensing external data, determining a risk level based on an analysis of the external data and the alertness of the occupant, and adjusting a seat adjustment function of the vehicle based on the risk level.

Yet another embodiment relates to a system comprising an alertness detector configured to detect an alertness signal of an occupant in a vehicle, an alertness determination unit configured to determine an alertness of the occupant based on the alertness signal, a sensing unit configured to sense external data, an analysis unit configured to analyze the external data, a risk assessment unit configured to determine a risk level based on an analysis of the external data and the alertness of the occupant; and human-machine interface configured to communicate the risk level and a suggestion to the occupant.

Yet another embodiment relates to a method comprising detecting an alertness signal of an occupant in a vehicle, determining an alertness of the occupant based on the alertness signal, sensing external data, determining a risk level based on an analysis of the external data and the alertness of the occupant, and communicating the risk level and a suggestion to the occupant.

Yet another embodiment relates to a non-transitory computer-readable medium having stored thereon instructions executable by a computer system to perform operations comprising detecting an alertness signal of an occupant in a vehicle, determining an alertness of the occupant based on the alertness signal, sensing external data, determining a risk level based on an analysis of the external data and the alertness of the occupant, and communicating the risk level and a suggestion to the occupant.

### BRIEF DESCRIPTION OF THE FIGURES

Aspects of the present invention will now be described in more detail, with reference to the appended drawings showing exemplary embodiments of the present invention, in which:

FIG. 1 shows a block diagram of a system for risk scenario adaption, according to an embodiment.

FIG. 2A is an illustration of an example autonomous vehicle with various sensors, actuators, and systems according to an embodiment.

FIG. 2B shows an example seat with various sensors, and retractors, according to an embodiment.

FIG. 3 is a diagram illustrating an example of a vehicle and various sensors that may be implemented in some configurations of the systems and methods disclosed herein.

FIG. 4A and FIG. 4B is a diagram illustrating an example of a vehicle and various sensors that may be implemented in some configurations of the systems and methods disclosed herein.

FIG. 5 illustrates example inputs to the system for risk level analysis according to an embodiment of the invention.

FIG. 6A illustrates a process flow diagram of a method for risk scenario adaption according to an embodiment of the invention.

FIG. 6B shows a block diagram of a system to predict a risk scenario and make adjustments, according to an embodiment.

FIG. 6C shows a block diagram of a non-transitory computer-readable medium to perform operations so as to predict a risk scenario, and adjust, according to an embodiment.

FIG. 7 illustrates a process flow diagram of a method for risk scenario adaption in a route according to an embodiment of the invention.

FIG. 8 illustrates a process flow diagram of a method for predicting a risk level, communicating a recommendation scenario adaption and communicating a risk level and a suggestion according to an embodiment of the invention.

FIG. 9A shows a structure of the neural network/machine learning model with a feedback loop according to an embodiment.

FIG. 9B shows a structure of the neural network/machine learning model with reinforcement learning according to an embodiment.

FIG. 9C shows an example block diagram for detecting alertness of an occupant using a machine learning model according to an embodiment.

FIG. 9D shows a neural network architecture for occupant alertness and risk assessment, according to an embodiment.

FIG. 10 shows an example flow chart for risk assessment using a machine learning model according to an embodiment.

FIG. 11A shows a block diagram of the cyber security module in view of the system and server according to an embodiment.

FIG. 11B shows an embodiment of the cyber security module according to an embodiment of the system.

FIG. 11C shows another embodiment of the cyber security module according to an embodiment of the system.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although herein the detailed description contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right.” “front.” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has.” “have,” “having.” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled.” “couples,” “coupling.” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably.” “removable.” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

As used herein, the term “component” broadly construes hardware, firmware, and/or a combination of hardware, firmware, and software.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multiprocessor systems, microprocessor-based or programmable consumer electronics, network PCs, minicomputers, mainframe computers, mobile telephones. PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall be understood to have the following meanings.

The term “vehicle” as used herein refers to a thing used for transporting people or goods. Automobiles, cars, trucks, buses etc. are examples of vehicles.

The term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems, designed for the purpose, interpret sensor information to identify appropriate navigation paths, as well as obstacles and relevant signage.

The term “autonomous mode” as used herein refers to an operating mode which is independent and unsupervised.

As used herein, the term “occupant” refers to any person or creature present inside the vehicle while it is in motion or stationary. This includes individuals who are sitting in the driver's seat, front passenger seat, or any of the back seats. Occupants can also include individuals who are standing or positioned in other parts of the vehicle, such as a person in the cargo area of a van or truck. The term occupant emphasizes the presence of individuals within the vehicle, regardless of their specific roles or responsibilities.

In the case of autonomous vehicles, the occupants typically assume a more passive role compared to traditional vehicles. In some cases, occupants in autonomous vehicles might not have specific driving responsibilities or tasks, as the vehicle's systems handle the driving tasks autonomously. Instead, occupants may primarily engage in other activities, such as working, reading, or relaxing, while the vehicle navigates the road.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

As used herein, the term “IoT” stands for Internet of Things which describes the network of physical objects “things” or objects embedded with sensors, software, and other technologies for the purpose of connecting and exchanging data with other devices and systems over the internet.

As used herein, “Seat belt sensor” is a device that detects the presence or engagement of a seat belt, ensuring its proper use.

As used herein, “Position sensor” is a sensor that determines and detects the position or orientation of an object or component.

As used herein, “Pressure sensor” is a sensor that measures and detects the force or pressure exerted on it, often used to monitor fluid or gas pressure.

As used herein, “Liquid detection sensor” is a sensor that identifies and detects the presence or level of liquids, often used to prevent spills or monitor fluid levels.

As used herein, “Weight sensor” is a sensor that measures and detects the weight or mass of an object or load placed upon it.

As used herein, “Infrared sensor” is a sensor that uses infrared radiation to detect and measure objects or movements within its range.

As used herein, “Optical sensor” is a sensor that utilizes light or optics to detect and measure various attributes such as distance, position, or presence.

As used herein, “Comfort detection sensor” is a sensor that gauges and detects comfort-related factors, such as temperature, humidity, or seating conditions.

As used herein, “Moisture sensor” is a sensor that detects and measures the moisture content or humidity level in its surrounding environment.

As used herein, “Temperature sensor” is a sensor that measures and detects the ambient temperature or the temperature of an object or substance.

As used herein, “Image sensor” is a sensor, typically found in digital cameras, that captures and converts optical images into electronic signals.

As used herein, “Video sensor” is a sensor capable of capturing and converting visual information into electronic signals, enabling video recording or monitoring.

As used herein, “Audio sensor” is a sensor, such as a microphone, that captures and converts sound or acoustic signals into electrical signals.

As used herein, “Ultrasound sensor” is a sensor that uses ultrasound waves to measure distance or detect objects, similar to how bats navigate.

As used herein, “Radar sensor” is a sensor that uses radio waves to detect and measure the position, distance, or movement of objects.

As used herein, “LiDAR sensor” is a sensor that employs lasers to measure distances and create detailed 3D maps of objects and surroundings.

As used herein, “Sound sensor” is a sensor that detects and captures sound waves, converting them into electrical signals for analysis or recording (e.g., microphones).

As used herein, “Motion sensor” is a sensor that detects and measures movement or changes in position, commonly used for security, automation, or occupancy detection purposes.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the AI/ML model improving the model's accuracy and performance over time.

Statistical modeling relies on finding relationships between variables (e.g., mathematical equations) to predict an outcome.

As used herein, the term “Data mining” is a process used to turn raw data into useful information.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “Sensor” is a device that measures physical input from its environment and converts it into data that is interpretable by either a human or a machine. Most sensors are electronic, which presents electronic data, but some are simpler, such as a glass thermometer, which presents visual data.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

Further, the communication apparatus is configured on a computer with the communication function and is connected for bidirectional communication with the on-vehicle emergency report apparatus by a communication line through a radio station and a communication network such as a public telephone network or by satellite communication through a communication satellite. The communication apparatus is adapted to communicate, through the communication network, with communication terminals.

The term “communication protocol” as used herein refers to standardized communication between any two systems. An example communication protocol is a DSRC protocol. The DSRC protocol uses a specific frequency band (e.g., 5.9 GHZ) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the IEEE and SAE International.

The term “bidirectional communication” as used herein refers to an exchange of data between two components. In an example, the first component can be a vehicle and the second component can be an infrastructure that is enabled by a system of hardware, software, and firmware.

The term “alert” or “alert signal” refers to a communication to attract attention. An alert may include visual, tactile, audible alert, and a combination of these alerts to warn drivers or occupants. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

“Size of a person” can comprise the following parameters, standing height, sitting height, shoulder length, neck circumference, neck width, chest circumference, chest width, waist circumference, waist width, hip circumference and hip width.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The term “electronic control unit” (ECU), also known as an “electronic control module” (ECM), is usually a module that controls one or more subsystems. Herein, an ECU may be installed in a car or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term “Vehicle Data bus” as used herein represents the interface to the vehicle data bus (e.g., CAN, LIN, Ethernet/IP, FlexRay, and MOST) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “turn lane,” or “turning lane,” is a specific lane on a roadway designated for vehicles to turn onto another road. It may also refer to a lane into which a vehicle is trying to make a turn. Turning lanes are typically marked with arrows on the pavement indicating the direction of the turn and may also have additional signage indicating which turns are permitted from that lane.

The term “nearby vehicle” or “neighboring vehicle” or “surrounding vehicle” as used herein refers to a vehicle anywhere near to the host vehicle within a communication range of the host vehicle. It may or may not be an autonomous vehicle. It may or may not have been enabled for V2V communication. In some embodiments, a neighboring vehicle may more specifically refer to a vehicle that is immediately in the next lane or behind the host vehicle.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc., to collect visual data about the vehicle's surroundings and to analyze that data in real-time. The computer vision module is designed to perform a range of tasks, including object detection, lane detection, and pedestrian recognition. It uses deep learning algorithms and other machine learning techniques to analyze the visual data and make decisions about how to control the vehicle. For example, the computer vision module may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, “seat recline” refers to an adjustment of the entire seat assembly, including both the seat cushion and the backrest, to achieve a more reclined position. Adjusting the seat recline provides a more relaxed or comfortable position, especially during long drives when occupant wants to rest.

As used herein, “backrest angle” refers specifically to the adjustment of the backrest portion of the seat, independent of the seat cushion. It allows to change the angle of the backrest relative to the vertical position. This is particularly useful for maintaining good posture while driving or for finding a comfortable position that suits body shape.

As referred herein, “lumbar supports” are features designed to provide additional lower back support for the occupants of the vehicle. These supports are typically built into the seats and can be adjusted to provide a customized fit for each occupant.

The lumbar support system in an autonomous vehicle may include features such as inflatable air bladders, mechanical adjustments, or even electronic sensors that can detect the occupant's body position and adjust the lumbar support accordingly. By providing additional support to the lower back, these features can help to reduce fatigue and discomfort during long periods of driving, as well as improve overall comfort and safety.

In addition to improving comfort for the occupants, lumbar support can also help to reduce the risk of injury in the event of a collision or sudden maneuver. By providing additional support to the lower back, these features can help to prevent whiplash and other injuries that can occur when the body is thrown forward or backward during a sudden stop or impact.

As referred herein, “electrical retractors” are motorized mechanisms that automatically adjust the position of the seat and seat belt to ensure a comfortable and safe ride for the occupants. These retractors are typically controlled by the vehicle's onboard computer and can be programmed to adjust the position of the seat and seat belt based on factors, such as the occupant's height, weight, and body shape.

The electrical retractors can be used to adjust the seat and seat belt in real-time, making changes based on the occupant's movements and the vehicle's driving conditions. For example, if the vehicle is accelerating or braking quickly, the seat belt may be tightened to keep the occupant securely in place. Similarly, if the vehicle is turning or cornering, the seat may be adjusted to help the occupant maintain a comfortable and stable position.

As used herein, “submarining” refers to a potential risk associated with reclined seating. Submarining occurs when a person in a reclined seat slides or slips under their seatbelt during a sudden deceleration, jerk, or collision. This can happen because the angle of the reclined seat may cause the lap belt to ride up over the pelvis, allowing the person's body to slide forward underneath the belt.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers-say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DOS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes usage of algorithms. A sufficiently detailed protocol includes details about data structures and representations, to implement multiple, interoperable versions of a program. Secure application-level data transport widely uses cryptographic protocols. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Networking switches use cryptographic protocols, like Secure Socket Layer (SSL) and Transport Layer Security (TLS), the successor to SSL, to secure data communications over a wireless network.

As used herein, the term “unauthorized access” is when someone gains access to a website, program, server, service, or other system using someone else's account or other methods. For example, if someone kept guessing a password or username for an account that was not theirs until they gained access, it is considered unauthorized access.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to conduct aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or conduct one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all aspects of the one or more embodiments described herein. In a distributed computing environment, program modules can be located in both local and remote memory storage devices.

As used in this application, the terms “component,” “system,” “platform,” “interface.” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store.” “storage.” “data store.” data storage,” “database.” and any other information storage component relevant to operation and functionality of a component refer to “memory components.” entities embodied in a “memory.” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synclink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes.” “has.” “possesses,” and the like are used in the detailed description, claims, appendices and/or drawings such terms are intended to be inclusive in a manner similar to the term “comprising” is interpreted when employed as a transitional word in a claim.

In the future, vehicles are expected to be equipped with automated driving capabilities, which will likely impact customer expectations and behaviors inside the car. One anticipated expectation in autonomous vehicles is the ability to utilize travel time in a more meaningful manner. A desired function is the option to recline the seat and rest or sleep comfortably during autonomous driving. However, reclined seating poses increased risks such as submarining and potentially compromised restraint effectiveness in the event of a crash. The objective of this disclosure is to mitigate these risks by allowing or restricting certain functions based on the assessed level of risk. Risks are minimized allowing certain functions when the environment is assessed to be low risk and limiting function when the risk is assessed to be higher. This will help accommodate customer expectations in a safe way.

According to one or more embodiments, a system is provided that is configured to enhance safety and comfort for occupants by dynamically adapting to various driving conditions and occupant needs. By leveraging advanced sensors, computer vision and artificial intelligence algorithms, the system provides real-time situational awareness and makes automatic adjustments to optimize seat belt tension and car seat positioning. The system is adaptive to different predetermined threat levels and adjusts the seat appropriately as the threat level changes during driving.

According to some embodiments of the system, a camera is operable to capture an image of the occupant in the car seat. According to an embodiment of the system, the image is analyzed using a computer vision algorithm comprising pattern recognition techniques to detect a human, body posture of the human, facial features of the human for at least one of an eye, a nose, a mouth, and an outline of a face, an car, a hair and determines alertness of the occupant.

The system can sense, (i) by a passenger-position sensor of the vehicle, a position of an occupant positioned in the autonomous vehicle, yielding occupant-position data; and/or (ii) by an occupant-gaze sensor of the vehicle, a gaze of the occupant, yielding occupant-gaze data. Occupant position can include various aspects of position, such as location, pose, and orientation, of the occupant generally or any part or parts of the occupant, such as their head or face. While occupant gaze is determined in various embodiments using one or more vehicle sensors, in another aspect, the technology relates to a process for monitoring attention of, and interacting selectively with, an occupant wearing smart eyewear or holding a mobile-communication device—e.g., tablet computer. The process includes receiving, from the occupant eyewear, including an occupant-gaze sensor, gaze data indicating a gaze of the occupant in a vehicle during driving.

The system utilizes sensors to determine threat levels and enable smart functions for vehicle occupants seated in a non-optimal way comprising one or more of a resting position, a sleeping position, and a working position.

The system also enables clever communication with the occupant emphasizing intelligent vehicles with no or little added cost.

An embodiment relates to a system comprising an alertness detector unit configured to detect an alertness signal of an occupant, an alertness determination unit configured to determine an alertness of the occupant based on the alertness signal, a sensing module configured to sense external data in a route, an analysis unit configured to analyze the external data to determine an external condition, a risk assessment unit configured to determine in real-time a real-time risk level based on an analysis of the external data and the alertness of the occupant, and a control unit configured to adjust a seat if determined that the real-time risk level was above a threshold.

In another embodiment, the alertness detector unit further comprises one or more of a seat adhered sensor, a vehicle adhered sensor, and a belt adhered sensor.

In yet another embodiment, the seat adhered sensor comprises plurality of sensors, wherein the plurality of sensors comprises a seat belt sensor, a position sensor, a pressure sensor, a liquid detection sensor, a weight sensor, an infrared sensor, an optical sensor, a comfort detection sensor, a moisture sensor, a temperature sensor, an image sensor, a video sensor, and an audio sensor.

In yet another embodiment, the vehicle adhered sensor comprises plurality of sensors, wherein the plurality of sensors comprises a seat belt sensor, a position sensor, a pressure sensor, a liquid detection sensor, weight sensor, an infrared sensor, an optical sensor, a comfort detection sensor, a moisture sensor, a temperature sensor, an image sensor, a video sensor, and an audio sensor.

In yet another embodiment, the belt adhered sensor comprises a plurality of sensors, wherein the plurality of sensors comprises a position sensor, a pressure sensor, a liquid detection sensor, a weight sensor, an infrared sensor, an optical sensor, a comfort detection sensor, a moisture sensor, a temperature sensor, an image sensor, a video sensor, and an audio sensor.

In yet another embodiment, the occupant is one or more of a driver and a passenger in the vehicle.

In yet another embodiment, the alertness determination unit comprises a computer vision module.

In yet another embodiment, the computer vision module analyzes an image to determine alertness of the occupant.

In yet another embodiment, the alertness signal comprises one or more of a seating position, a body posture, a head position, a head angle, a head tilt, and an eye gaze position.

In yet another embodiment, the occupant is one or more of a driver and a passenger in a vehicle.

In yet another embodiment, the external data comprises one or more of speedometer data, Global Positioning System (GPS) data, road condition data, traffic data, vehicle-to-vehicle (V2V) data, vehicle-to-infrastructure (V2I) data, weather information, and pre-crash information.

In yet another embodiment, the real-time risk level comprises one of a low-risk level, a mid-risk level, and a high-risk level. Table 1 below provides an example of risk levels, according to one or more embodiments.

| Risk level | Risk condition | Control unit action |
|---|---|---|
| High risk: | Road Type: Autobahn | Restrict safe resting |
| Level 1 | Road Condition: Icy and snow-covered | position |
| | Traffic Condition: Heavy traffic | |
| | Weather Condition: Blowing snow and strong | |
| | winds. | |
| | Lane Reduction: None | |
| High risk: | Road Type: Freeway | Limited restriction, auto |
| Level 2 | Road Condition: Potholes and uneven pavement | move |
| | Traffic Condition: Stop-and-go traffic. | |
| | Weather Condition: Sunny with strong crosswinds | |
| | Lane Reduction: None | |
| High risk: | Road Type: Expressway | Restrict, auto move. |
| Level 3 | Road Condition: Icy and slippery | Restrict, auto move. |
| | Traffic Condition: Heavy traffic congestion | Restrict, auto move |
| | Weather Condition: Snowstorm with poor | |
| | visibility | |
| | Lane Reduction: None | |
| Mid risk | Road Type: Expressway | Auto move |
| Level 4 | Road Condition: Wet and slippery | |
| | Traffic Condition: Moderate traffic | |
| | Weather Condition: Heavy rain | |
| | Lane Reduction: Construction zone with | |
| | temporary lane closures | |
| Mid risk | Road Type: Highway | Limited restriction, auto |
| Level 5 | Road Condition: Freshly paved and smooth | move |
| | Traffic Condition: Moderate traffic flow | |
| | Weather Condition: Foggy with reduced visibility | |
| | Lane Reduction: Construction zone with lane | |
| | closures | |
| Mid risk | Road Type: Autobahn | Limited restriction, auto |
| Level 6 | Road Condition: Smooth and well-maintained | move |
| | Traffic Condition: Light traffic flow | |
| | Weather Condition: Clear skies with mild winds | |
| | Lane Reduction: Construction zone with lane | |
| | closures | |
| Mid risk | Road Type: Freeway | No restriction |
| Level 7 | Road Condition: Newly resurfaced and smooth | |
| | Traffic Condition: Free-flowing traffic | |
| | Weather Condition: Clear skies and sunny | |
| | Lane Reduction: Temporary Lane closure due to | |
| | maintenance | |
| Low risk | Road Type: Highway | No restriction |
| Level 8 | Road Condition: Dry and smooth | |
| | Traffic Condition: Light traffic | |
| | Weather Condition: Clear skies | |
| | Lane Reduction: None | |
| Low risk | Road Type: Autobahn | Limited restriction |
| Level 9 | Road Condition: Wet with intermittent heavy rain | |
| | showers | |
| | Traffic Condition: Sparse traffic | |
| | Weather Condition: Thunderstorm with lightning | |
| | Lane Reduction: None | |
| Low risk | Road Type: Highway | Limited restriction |
| Level 10 | Road Condition: Bumpy and pothole-ridden | |
| | Traffic Condition: Moderate traffic flow | |
| | Weather Condition: Heavy rain with reduced | |
| | visibility | |
| | Lane Reduction: None | |

In yet another embodiment, the system further comprises: a routing unit configured to generate the route to be pursued by a vehicle, a prediction unit configured to predict an upcoming road condition, and a recommendation unit configured to provide a recommendation for a suitable seating position based on the upcoming road condition.

In yet another embodiment, the recommendation unit is further configured to provide an updated recommendation for the suitable seating position based on the real-time risk level.

In yet another embodiment, computer vision module comprises an artificial intelligence engine comprising a machine learning algorithm.

In yet another embodiment, the machine learning algorithm comprises one or more of a shape predictors algorithm, a support vector machine, a random forest algorithm, and Long Short-Term Memory (LSTM) network.

In yet another embodiment, a machine learning module is configured to train a machine learning model.

In yet another embodiment, the machine learning model is a neural network model.

In yet another embodiment, the neural network model is one or more of a recurrent neural network model and a convolutional neural network.

In yet another embodiment, the machine learning module is configured to train based on at least one of a Random Forest algorithm, a Bayesian network algorithm, a Support vector machine algorithm, and a penalized logistic regression algorithm.

In yet another embodiment, the machine learning module is configured to train the artificial intelligence engine.

In yet another embodiment, the machine learning module is configured to train the risk assessment unit of the system.

In yet another embodiment, the external condition is one or more of a weather condition, a lane reduction, a traffic condition, a winding route, an icy road, a neighboring car, a sloped road, and a road turn.

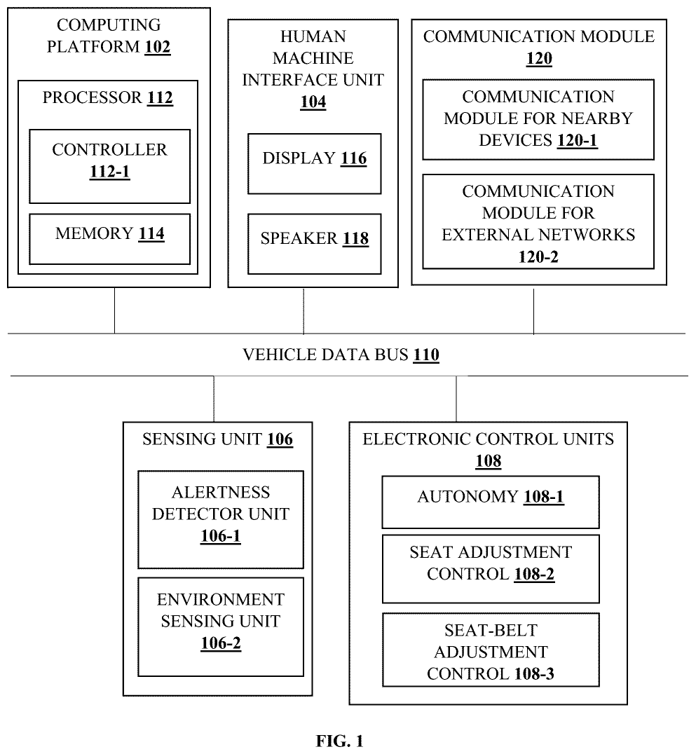

Referring to FIG. 1, it shows a block diagram of a system for risk scenario adaption, according to an embodiment. In the illustrated example, the electronic components include a computing platform 102, a human-machine interface (HMI) unit 104, a communication module 120, a sensing unit 106, an electronic control unit (ECU) 108, and a vehicle data bus 110.

The onboard computing platform 102 includes a processor 112 (also referred to as a microcontroller unit or a controller) and memory 114. In the illustrated example, processor 112 of the computing platform 102 is structured to include the controller 112-1. In other examples, the controller 112-1 is incorporated into another ECU with its own processor and memory. The processor 112 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 114 may be volatile memory (e.g., RAM including non-volatile RAM, magnetic RAM, ferroelectric RAM, etc.), non-volatile memory (e.g., disk memory, FLASH memory, EPROMS, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 114 includes multiple kinds of memory, particularly volatile memory, and non-volatile memory. Memory 114 is computer readable media on which one or more sets of instructions, such as the software for operating the methods of the present disclosure, can be embedded. The instructions may embody one or more of the methods or logic as described herein. For example, the instructions reside completely, or at least partially, within any one or more of memory 114, the computer readable medium, and/or within the processor 112 during execution of the instructions.

The HMI unit 104 provides an interface between the vehicle and a user. The HMI unit 104 includes digital and/or analog interfaces (e.g., input devices and output devices) to receive input from, and display information for, the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), haptic devices, actuators, a display 116 (e.g., a heads-up display, a center console display such as a liquid crystal display (LCD), an organic light emitting diode (OLED) display, a flat panel display, a solid state display, etc.), and/or a speaker 118. For example, the display 116, the speaker 118, and/or other output device(s) of the HMI unit 104 are configured to emit an alert, such as an alert to request manual takeover, to an operator (e.g., a driver) of the vehicle. Further, the HMI unit 104 of the illustrated example includes hardware (e.g., a processor or controller, memory, storage, etc.) and software (e.g., an operating system, etc.) for an infotainment system that is presented via display 116.

The sensing unit 106 comprises an alertness detection unit 106-1 and an environment sensing unit 106-2. The sensing unit 106 comprises one or more sensors that are arranged in and/or around the vehicle to monitor properties of the vehicle and/or an environment in which the vehicle is located and/or an alertness level of an occupant. Additionally, or alternatively, one or more of sensors 106 may be mounted inside a cabin of the vehicle or in a body of the vehicle (e.g., an engine compartment, wheel wells, etc.) to measure properties of the vehicle and/or interior of the vehicle. For example, the sensors 106 include accelerometers, odometers, tachometers, pitch and yaw sensors, wheel speed sensors, microphones, tire pressure sensors, biometric sensors, ultrasonic sensors, infrared sensors, Light Detection and Ranging (lidar), Radio Detection and Ranging System (radar), Global Positioning System (GPS), cameras and/or sensors of any other suitable type. In the illustrated example, sensors 106 include the range-detection sensors that are configured to monitor object(s) located within a surrounding area of the vehicle.

In some embodiments, the environment sensing unit 106-2 employs a road state monitoring system that utilizes a thermal imaging camera to monitor road situations accurately. The camera analyzes captured images and displays monitoring results to drivers, reducing the risk of traffic accidents and enhancing road management efficiency. By equipping road management vehicles with thermal imaging cameras and display units, the system enables real-time monitoring throughout the road management section, facilitating effective road condition assessments.

In some embodiments, the environment sensing unit 106-2 may utilize dual camera-enabled electronic devices, supported by intelligent computer vision algorithms. These devices monitor the road and driver simultaneously, issuing audio and visual alerts for various driving-related conditions and distractions, such as lane monitoring, very nearby vehicle detection, obstacles, pedestrians, driver fatigue, and inattention. This comprehensive alert system enhances driver safety in diverse environmental conditions. Various sensors can sense nearby vehicle movements, angular velocity, and latitude and longitude. By processing the collected data and employing machine learning algorithms, the system can classify road conditions and provide real-time recommendation on seat adjustments to drivers, ensuring a comfortable and safe driving experience.

The methods depicted herein may include fusing a set of data related to vehicle, seat and seat belt, a set of data related to vehicle surroundings, and a set of data related to occupant body features, body posture and alertness. In an exemplary embodiment, the sensing unit may communicate with the neural network processing unit to provide artificial intelligence capabilities to conduct multimodal fusion. The sensing unit may utilize one or more machine learning/deep learning fusion processes to aggregate the set of data related to vehicle, seat and seat belt, the set of data related to vehicle surroundings, and the set of data related to occupant body features, body posture and alertness.

In particular, the neural network processing unit may execute machine learning/deep learning to determine one or more motion patterns from the fused data based on the evaluation of the fused data against the stored dynamic parameters, image recognition parameters, and object recognition parameters.

The ECUs 108 monitor and control the subsystems of the vehicle. For example, the ECUs 108 are discrete sets of electronics that include their own circuit(s) (e.g., integrated circuits, microprocessors, memory, storage, etc.) and firmware, sensors, actuators, and/or mounting hardware. The ECUs 108 communicate and exchange information via a vehicle data bus (e.g., the vehicle data bus 110). Additionally, the ECUs 108 may communicate properties (e.g., status of the ECUs, sensor readings, control state, error, and diagnostic codes, etc.) and/or receive requests from each other. For example, the vehicle may have dozens of the ECUs that are positioned in various locations around the vehicle and are communicatively coupled by the vehicle data bus 110.

In the illustrated example, the ECUs 108 include the autonomy unit 108-1, a seat adjustment control unit 108-2, and a seat belt adjustment control unit 108-3. For example, the autonomy unit 108-1 is configured to perform autonomous and/or semi-autonomous driving maneuvers (e.g., defensive driving maneuvers) of the vehicle based upon, at least in part, instructions received from the controller 112-1 and/or data collected by the sensors 106 (e.g., range-detection sensors). Further, the seat adjustment control unit 108-2 controls one or more retractors of seat, such as Emergency Locking Retractors (ELRs), Automatic Locking Retractors (ALRs), Motorized Retractors, Pretensioners.

ELRs are widely used in vehicles and engage during sudden stops or collisions. They lock the seat belt in place to prevent excessive movement and help restrain occupants during impact. ALRs are designed to secure child safety seats or allow for the secure installation of other equipment. They lock the seat belt at a certain point and prevent it from extending further, providing a stable and secure anchor point. ELRs are equipped with a mechanism that responds to sudden accelerations or decelerations. They use inertia sensors to lock the seat belt when rapid changes in motion are detected, ensuring occupant restraint. Motorized retractors utilize electric motors to automatically adjust the seat belt tension and position. They can be integrated into advanced seat adjustment systems, enabling precise and automated control of seat belt length and tension.

While not technically retractors, pretensioners are often paired with retractors. Pretensioners retract the seat belt rapidly during a collision or sudden stop, removing slack and tightening the belt against the occupant's body for enhanced restraint, etc.

The vehicle data bus 110 communicatively couples the communication module 120, the onboard computing platform 102, the HMI unit 104, the sensing unit 106, and the ECUs 108. In some examples, the vehicle data bus 110 includes one or more data buses. The vehicle data bus 110 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

The communication module 120-1 is configured to communicate with other nearby communication devices. In the illustrated example, communication module 120 includes a dedicated short-range communication (DSRC) module. A DSRC module includes antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication.

V2V communication allows vehicles to share information such as speed, position, direction, and other relevant data, enabling them to cooperate and coordinate their actions to improve safety, efficiency, and mobility on the road. V2V communication can be used to support a variety of applications, such as collision avoidance, lane change assistance, platooning, car seat adjustment, seat belt adjustment, risk assessment, and traffic management. It may rely on dedicated short-range communication (DSRC) and other wireless protocols that enable fast and reliable data transmission between vehicles. V2V communication is a form of wireless communication between vehicles that allows vehicles to exchange information and coordinate with other vehicles on the road. V2V communication enables vehicles to share data about their location, speed, direction, acceleration, and braking with other nearby vehicles, which can help improve safety, reduce congestion, and enhance the efficiency of transportation systems.

V2V communication is typically based on wireless communication protocols such as Dedicated Short-Range Communications (DSRC) or Cellular Vehicle-to-Everything (C-V2X) technology. With V2V communication, vehicles can receive information about potential hazards, such as accidents or road closures, and adjust their behavior accordingly.

More information on the DSRC network and how the network may communicate with vehicle hardware and software is available in the U.S. Department of Transportation's Core June 2011 System Requirements Specification (SyRS) report (available at http://wwwits.dot.gov/meetings/pdf/CoreSystemSESyRSRevA%20(2011-06-13).pdf). DSRC systems may be installed on vehicles and along roadsides on infrastructure. DSRC systems incorporating infrastructure information are known as a “roadside” system. DSRC may be combined with other technologies, such as Global Position System (GPS), Visual Light Communications (VLC), Cellular Communications, and short-range radar, facilitating the vehicles communications their position, speed, heading, relative position to other objects and to exchange information with other vehicles or external computer systems. DSRC systems can be integrated with other systems such as mobile phones.

Currently, the DSRC network is identified under the DSRC abbreviation or name. However, other names are sometimes used, usually related to a Connected Vehicle program or the like. Most of these systems are either pure DSRC or a variation of the IEEE 802.11 wireless standard. However, besides the pure DSRC system it is also meant to cover dedicated wireless communication systems between vehicles and roadside infrastructure systems, which are integrated with GPS and are based on an IEEE 802.11 protocol for wireless local area networks (such as 802.11p, etc.).

Additionally, or alternatively, the communication module 120-2 includes a cellular vehicle-to-everything (C-V2X) module. A C-V2X module includes hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is configured to communicate with nearby devices (e.g., vehicles, roadside units, mobile devices, etc.) directly and/or via cellular networks. Currently, standards related to C-V2X communication are being developed by the 3rd Generation Partnership Project.

Further, the communication module 120-2 is configured to communicate with external networks. For example, the communication module 120-2 includes hardware (e.g., processors, memory, storage, antenna, etc.) and software to control wired or wireless network interfaces. In the illustrated example, the communication module 120-2 includes one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module 120-2 includes a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols.

In an embodiment, the communication module is enabled for an autonomous communication, wherein the autonomous communication comprises communication over a period with minimal supervision under different scenarios. The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

The autonomy unit 108-1 of the illustrated example is configured to perform autonomous and/or semi-autonomous driving maneuvers, such as defensive driving maneuvers, for the vehicle. For example, the autonomy unit 108-1 performs the autonomous and/or semi-autonomous driving maneuvers based on data collected by the sensors 106. In some examples, the autonomy unit 108-1 is configured to operate a fully autonomous system, a park-assist system, an advanced driver-assistance system (ADAS), and/or other autonomous system(s) for the vehicle.

An ADAS is configured to assist a driver in safely operating the vehicle. For example, the ADAS is configured to perform adaptive seat adjustment, adaptive seat belt adjustment, cruise control, collision avoidance, lane-assist (e.g., lane centering), blind-spot detection, rear-collision warning(s), lane departure warnings and/or any other function(s) that assist the driver in operating the vehicle. To perform the driver-assistance features, the ADAS monitors objects (e.g., vehicles, pedestrians, traffic signals, etc.) and develops situational awareness around the vehicle. For example, the ADAS utilizes data collected by the sensors 106, the communication module 220-1 (e.g., from other vehicles, from roadside units, etc.), the communication module 120-2 from a remote server, and/or other sources to monitor the nearby objects and develop situational awareness.

Further, in the illustrated example, controller 112-1 is configured to monitor an ambient environment of the vehicle. For example, to enable the autonomy unit 108-1 to perform autonomous and/or semi-autonomous driving maneuvers, the controller 112-1 collects data that is collected by the sensors 106 of the vehicle. In some examples, the controller 112-1 collects location-based data via the communication module 120-1 and/or another module (e.g., a GPS receiver) to facilitate the autonomy unit 108-1 in performing autonomous and/or semi-autonomous driving maneuvers. Additionally, the controller 112-1 collects data from (i) adjacent vehicle(s) via the communication module 120-1 and V2V communication and/or (ii) roadside unit(s) via the communication module 120-1 and V2I communication to further facilitate the autonomy unit 108-1 in performing autonomous and/or semi-autonomous driving maneuvers.

The communication module enables in-vehicle communication, communication with other vehicles, infrastructure communication, grid communication, etc., using Vehicle to network (V2N), Vehicle to infrastructure (V2I), Vehicle to vehicle (V2V), Vehicle to cloud (V2C), Vehicle to pedestrian (V2P), Vehicle to device (V2D), Vehicle to grid (V2G) communication systems. Then, the system notifies nearby or surrounding vehicles or vehicles communicating with the target vehicle's communication module. The vehicle uses, for example, a message protocol, a message that goes to the other vehicles via a broadcast.

In an embodiment, the system is part of a vehicle. In another embodiment, the vehicle comprises various sensors, actuators, systems, and subsystems. In yet another embodiment, the vehicle adhered sensor comprises plurality of sensors, wherein the plurality of sensors comprises a seat belt sensor, a position sensor, a pressure sensor, a liquid detection sensor, weight sensor, an infrared sensor, an optical sensor, a comfort detection sensor, a moisture sensor, a temperature sensor, an image sensor, a video sensor, and an audio sensor.

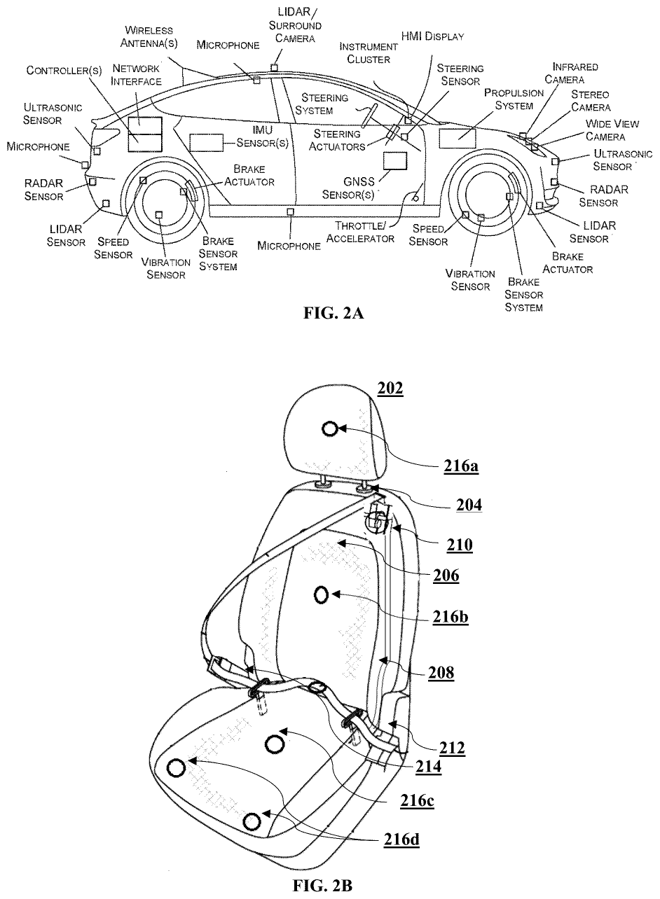

FIG. 2A is an illustration of an example autonomous vehicle with various sensors, actuators, and systems according to an embodiment. The Autonomous system comprises various sensors, such as ultrasonic sensor, lidar sensors (lidars), radar sensors, etc., actuators such as brake actuator, steering actuators, etc., and various subsystems such as propulsion system, steering system, brake sensor system, communication system, etc. FIG. 2A is depicted as an example system; neither is it limited by the systems depicted nor is it an exhaustive list of the sensors, actuators, and systems/subsystems, and/or features of the autonomous vehicle. Further, the vehicle shown should not be construed as limiting in terms of the arrangement of any of the sensors, actuators, and systems/subsystems depicted. These sensors, actuators, and systems/subsystems can be arranged as suited for a purpose to be performed by the autonomous vehicle. Autonomous vehicles, also known as self-driving vehicles or driverless vehicles, are vehicles that can navigate and operate without human intervention. Sensors, for example, including cameras, lidars, radars, and ultrasonic sensors, enable autonomous vehicles to detect and recognize objects, obstacles, and pedestrians on the road. Autonomous vehicles use advanced control systems to make real-time decisions based on sensor data and pre-programmed rules or intelligence-based decision systems. These systems control, for example, acceleration, braking, steering, and communication of the vehicle. Navigation systems such as GPS, maps, and other location-based technologies help autonomous vehicles navigate and plan the optimal route to a destination. Communication systems of autonomous vehicles help them communicate with other vehicles and infrastructure, such as traffic lights and road signs, to exchange information and optimize traffic flow. Autonomous vehicles have several safety features, including collision avoidance systems, emergency braking, and backup systems in case of system failures. Autonomous vehicles are assisted by artificial intelligence and machine learning algorithms to analyze data, recognize patterns, and improve performance over time.

In yet another embodiment, the control unit is further configured to restrict the seat adjustment function based on the real-time risk level.

In yet another embodiment, the seat adjustment function comprises one or more of a seat recline, a seat height, a payout, a backrest angle, a lumbar support adjustment, a seat belt tightness, a seat belt adjustment, and a seat belt travel length.

In yet another embodiment, the control unit adjusts the seat adjustment function via a retractor.

In yet another embodiment, the retractor is an electro-mechanical retractor.

In yet another embodiment, the control unit adjusts the seat adjustment function based on height, weight, and size of the occupant.

The car seat is equipped with various sensors, including pressure sensors, a seat belt sensor, a position sensor, a pressure sensor, weight sensor, an infrared sensor, an optical sensor, a comfort detection sensor, a force measurement sensor, an audio sensor, and a Radio Frequency Identification sensor. These sensors continuously monitor occupant movements, body posture, and vehicle dynamics. The car seat also comprises sensors to detect the height, weight and body structure of the occupant and can accordingly adjust the car seat or the seat belt.

In yet another embodiment, presence of the occupant on a seat is detected using one or more sensors comprising an infrared sensor, an ultrasound sensor, a radar sensor, a lidar sensor, a sound sensor (e.g., microphones), a weight sensor, and a motion sensor.

In yet another embodiment, a position of the occupant on a seat is detected using one or more of a microphone, a lidar sensor, a sound sensor, and a vision sensor.

In an embodiment, the sensing unit is capable of measuring pressure distributions across multiple ranges of a seat surface. The sensing device comprises a seat surface part placed on the seat or a lower-body wearable worn by the user. A plurality of pressure sensors, utilizing electrical resistance values, are strategically positioned in the femoral and buttock regions of the seat surface part or the lower-body wearable. The pressure distributions and their temporal variations can be accurately measured and utilized to control the operation of a device or the seat based on the measurement results.

In yet another embodiment, the seat adhered sensor comprises plurality of sensors, wherein the plurality of sensors comprises a seat belt sensor, a position sensor, a pressure sensor, a liquid detection sensor, a weight sensor, an infrared sensor, an optical sensor, a comfort detection sensor, a moisture sensor, a temperature sensor, an image sensor, a video sensor, and an audio sensor.

In yet another embodiment, the belt adhered sensor comprises a plurality of sensors, wherein the plurality of sensors comprises a position sensor, a pressure sensor, a liquid detection sensor, a weight sensor, an infrared sensor, an optical sensor, a comfort detection sensor, a moisture sensor, a temperature sensor, an image sensor, a video sensor, and an audio sensor.

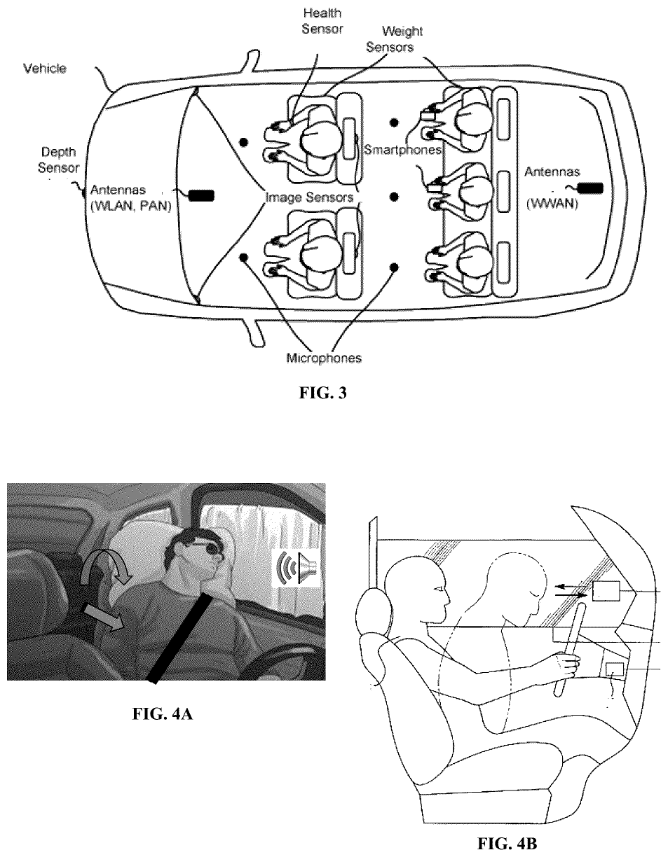

Referring to FIG. 2B, shows an example seat with various sensors, and retractors, according to an embodiment. The car seat 202 comprises a seat belt 204, a seat lumbar 206, a seat belt webbing, a seat belt retractor 208, a recliner sensor 210, a seat retractor 212, a seat belt buckle 214 and sensors (for example: height sensor 216a, position sensor 216b, weight sensor 216c and pressure sensor 216d). Referring to FIG. 3, it illustrates an example of a vehicle and various sensors that may be implemented in some configurations of the systems and methods disclosed herein. The system can monitor every occupant individually, analyze the body features, position, and can predict an impact for each of the occupants. Accordingly, based on the risk analysis and the seating posture of individuals, the system can adjust the seat or seat belt configuration for each individual.

Referring to FIG. 4A and FIG. 4B, they illustrate various communication means that may be implemented in some configurations of the systems and methods disclosed herein. In FIG. 4A, the system provides a voice alert to the occupant. In FIG. 4B, the system provides a visual alert to the occupant who is in active state via a display on the vehicle infotainment system.

According to an embodiment of the system, the system is operable to capture, via the sensors, an interior of the vehicle, surrounding of the vehicle and occupant/s body features and body posture. Data from the sensors on the child safety seat, vehicle seat belt, vehicle seat, attachment points are collected via a connector which would connect to the vehicle system.

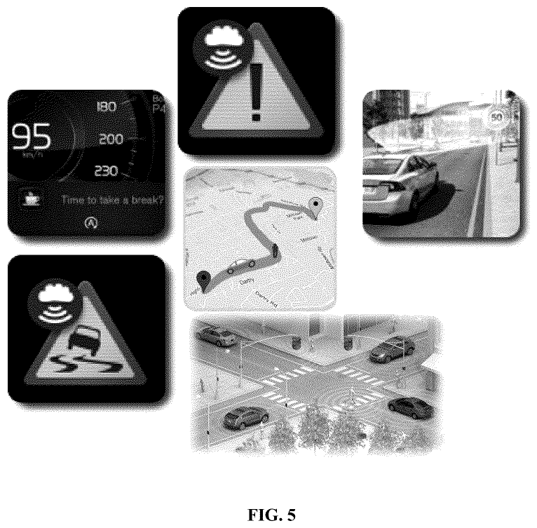

Referring to FIG. 5, it illustrates example inputs to the system for risk level analysis according to an embodiment of the invention. The input comprises one or more of Speedometer data, Global Positioning System (GPS) data (Highway, freeway, parking, etc.), road condition data, traffic information data (congestion, accidents etc.), vehicle to vehicle (V2V) information, and pre-crash information.

In an embodiment, AI algorithms analyze the sensor data in real-time to assess the current driving conditions and occupant behavior. This includes factors such as vehicle acceleration, deceleration, cornering, and sudden maneuvers.

Based on the situational analysis, the system adjusts the tension of the seat belt accordingly. For example, during sudden braking or acceleration, the system detects the change in forces and tightens the seat belt to ensure a secure fit and prevent excessive movement.

In some embodiments, the system also evaluates the occupant's posture and adjusts the car seat position to maintain proper alignment and support. It takes into account factors such as lumbar support, headrest position, and seat recline to enhance comfort and reduce the risk of injuries.

The measurement of lumbar support configuration in a vehicle typically involves assessing various factors related to the design and adjustability of the lumbar support. One aspect to consider is the range of adjustment offered by the lumbar support feature. This involves evaluating how much the lumbar support can be adjusted, both in terms of depth (how far it protrudes from the seatback) and firmness (how much resistance it offers). A wider range of adjustment allows for more customization and can accommodate a broader range of user preferences. Pressure mapping systems can be utilized to measure the pressure distribution on the user's back while sitting in the seat. By using pressure-sensitive sensors or mats, the distribution of pressure can be visualized and analyzed. This can help determine if the lumbar support effectively redistributes pressure and provides adequate support to the lower back.

In some embodiments, the system allows users to create personalized profiles, taking into consideration their body measurements and preferences. These profiles are stored and utilized to provide tailored adjustments for each individual occupant.

In some embodiments, in situations where the occupant's seat belt is improperly fastened or not fastened at all, the system provides immediate alerts and notifications to remind and encourage proper seat belt usage.

In some embodiments, the system logs data related to seat belt usage, occupant positioning, and driving conditions. This information can be accessed by vehicle owners, fleet managers, or safety authorities for analysis, monitoring compliance, and identifying areas for improvement.

By integrating situational awareness with seat belt and car seat adjustments, the system enhances occupant safety, promotes proper seat belt usage, and optimizes comfort during various driving scenarios. Restriction of functions depends on assessed risk level based on various information such as: V2V data, V2I data, Traffic information, GPS information, weather information, etc. External data is analyzed by the vehicles and a risk level is set depending on various external data. A lower risk level will allow more functionality, e.g., reclining the seat back for sleep/rest during drive. Higher risk levels will restrict how much the seat can recline and/or bring an already reclined seat to an adjustment that is appropriate if a higher risk level is set during driving.

A Threat level is established by the system using various inputs such as: Speedometer data, GPS data (highway, freeway, parking, etc.), Road condition data, Traffic information data (congestion, accidents, etc.), V2V information, Pre-crash information, and the like. A Low threat level (allows more functions, e.g., reclined seat backs in safe resting, safe sleeping, etc.) and less restrictions. An example scenario for a low threat level is a protected road with no intersections and no meeting traffic and good weather with low traffic.

A high threat level enables more restrictions (restricted back rest angles and seating positions, postures with higher risk). Example scenarios for a high threat level are deteriorated weather conditions, traffic congestion ahead, slippery roads ahead and getting close to exit from protected roads.

In some embodiments, the system is configured to automatically reset a seat in resting position with appropriate warning and/or information to the occupant.

In some embodiments, the system is configured to inform the occupant via an audio alarm or a lamp alarm.

In some embodiments, the system is configured to automatically implement restrictions on seat and seat belt adjustment when the system senses a high threat level.

Another embodiment relates to a method comprising: detecting an alertness signal of an occupant in a vehicle, determining an alertness of the occupant based on the alertness signal, sensing external data, determining a risk level based on an analysis of the external data and the alertness of the occupant, and adjusting a seat adjustment function of the vehicle based on the risk level.

In an embodiment, the method further comprises generating a route to be pursued by the vehicle, predicting an upcoming road condition, and providing recommendation for a suitable seating position based on the upcoming road condition.

In another embodiment, the method further comprises providing an updated recommendation for the suitable seating position based on the risk level in real-time.

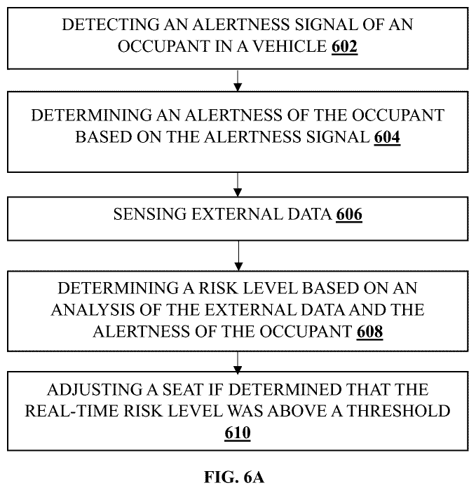

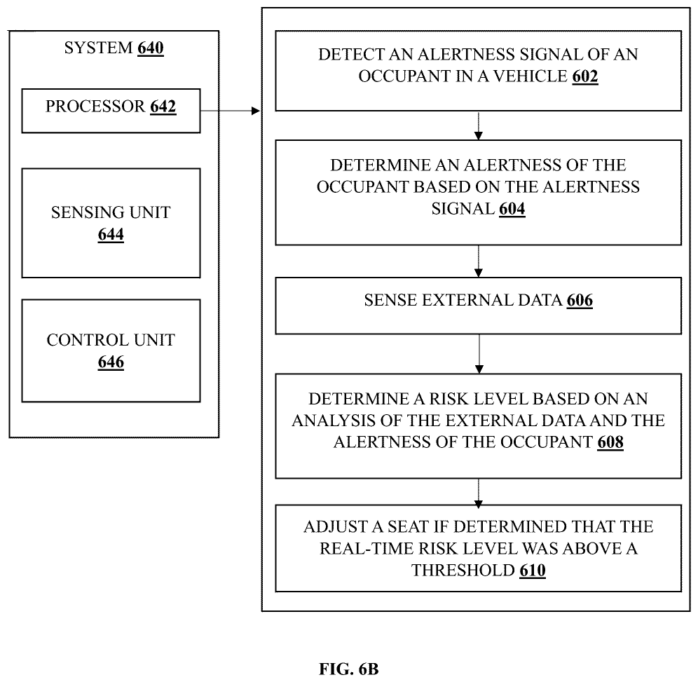

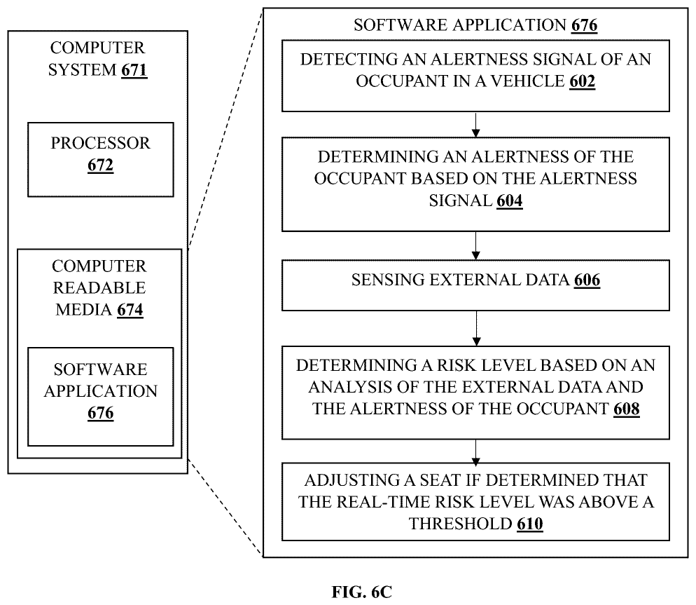

Referring to FIG. 6A, it illustrates a process flow diagram of a method for risk scenario adaption according to an embodiment of the invention. The method 600 comprises the following steps:
Step 602 of the method 600 comprises detecting an alertness signal of an occupant in a vehicle.
Step 604 of the method 600 comprises determining an alertness of the occupant based on the alertness signal.
Step 606 of the method 600 comprises sensing external data.
Step 608 of the method 600 comprises determining a risk level based on an analysis of the external data and the alertness of the occupant.
Step 610 of the method 600 comprises adjusting a seat adjustment function of the vehicle based on the risk level.

Referring to FIG. 6B, it shows a block diagram of a system to predict a risk scenario, and adjust according to an embodiment. The system 640 comprises a processor 642, a sensing unit 644, and a control unit 646. The processor is operable to detect an alertness signal of an occupant in a vehicle 602, determine an alertness of the occupant based on the alertness signal 604, sense external data 606, determine a risk level based on an analysis of the external data and the alertness of the occupant 608, and adjust a seat if determined that the real-time risk level was above a threshold. 610.

Yet another embodiment relates to a non-transitory computer-readable medium having stored thereon instructions executable by a computer system to perform operations comprising: detecting an alertness signal of an occupant in a vehicle, determining an alertness of the occupant based on the alertness signal, sensing external data, determining a risk level based on an analysis of the external data and the alertness of the occupant, and adjusting a seat adjustment function of the vehicle based on the risk level.

Referring to FIG. 6C, it shows a block diagram of a non-transitory computer-readable medium to perform operations so as to predict a risk scenario, and adjust, according to an embodiment. The non-transitory computer-readable medium 674 having stored thereon instructions executable by a computer system 671 comprising a processor 672 to perform operations via software application 676 comprising: detecting an alertness signal of an occupant in a vehicle 602, determining an alertness of the occupant based on the alertness signal 604, sensing external data 606, determining a risk level based on an analysis of the external data and the alertness of the occupant 608, and adjusting a seat adjustment function of the vehicle based on the risk level 610.

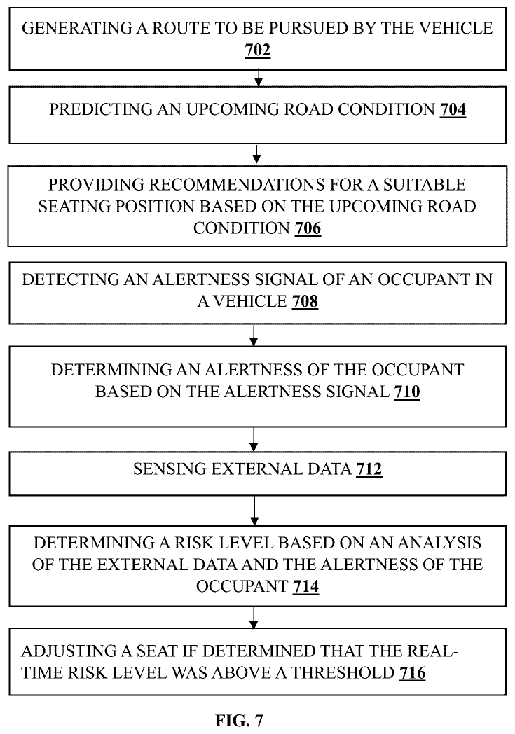

Referring to FIG. 7, it illustrates a process flow diagram of a method for risk scenario adaption in a route according to an embodiment of the invention. The method 700 comprises the following steps:
Step 702 of the method 700 comprises generating a route to be pursued by the vehicle.
Step 704 of the method 700 comprises predicting an upcoming road condition.
Step 706 of the method 700 comprises providing recommendations for a suitable seating position based on the upcoming road condition.
Step 708 of the method 700 comprises detecting an alertness signal of an occupant in a vehicle.
Step 710 of the method 700 comprises determining an alertness of the occupant based on the alertness signal.
Step 712 of the method 700 comprises sensing external data.
Step 714 of the method 700 comprises determining a risk level based on an analysis of the external data and the alertness of the occupant.
Step 716 of the method 700 comprises adjusting a seat adjustment function of the vehicle based on the risk level.

Yet another embodiment relates to a system comprising: an alertness detector configured to detect an alertness signal of an occupant in a vehicle, an alertness determination unit configured to determine an alertness of the occupant based on the alertness signal, a sensing unit configured to sense external data, an analysis unit configured to analyze the external data, a risk assessment unit configured to determine a risk level based on an analysis of the external data and the alertness of the occupant, and human-machine interface configured to communicate the risk level and a suggestion to the occupant.

In an embodiment, the human-machine interface comprises one or more of a screen, a voice message, a visible signal.

Yet another embodiment relates to a method comprising: detecting an alertness signal of an occupant in a vehicle, determining an alertness of the occupant based on the alertness signal, sensing external data, determining a risk level based on an analysis of the external data and the alertness of the occupant, and communicating the risk level and a suggestion to the occupant.

In an embodiment, the communicating comprises providing one or more of a visual cue and an audible cue.

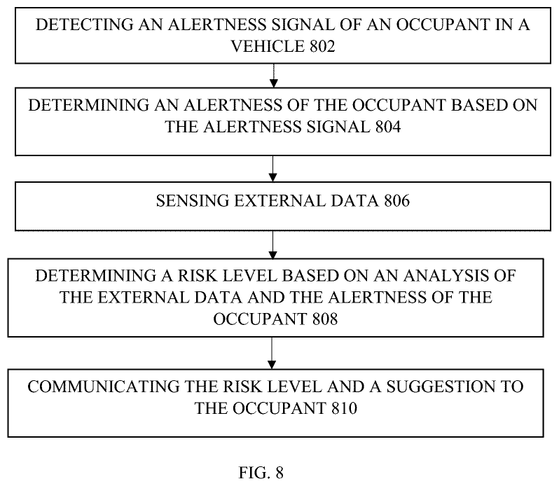

Referring to FIG. 8, it illustrates a process flow diagram of a method for predicting a risk level and communicating a recommendation scenario adaption and communicating a risk level and a suggestion according to an embodiment of the invention. The method 800 comprises the following steps:
Step 802 of the method 800 comprises detecting an alertness signal of an occupant in a vehicle.
Step 804 of the method 800 comprises determining an alertness of the occupant based on the alertness signal.
Step 806 of the method 800 comprises sensing external data.
Step 808 of the method 800 comprises determining a risk level based on an analysis of the external data and the alertness of the occupant.
Step 810 of the method 800 comprises communicating the risk level and a suggestion to the occupant.

Yet another embodiment relates to non-transitory computer-readable medium having stored thereon instructions executable by a computer system to perform operations comprising detecting an alertness signal of an occupant in a vehicle, determining an alertness of the occupant based on the alertness signal, sensing external data, determining a risk level based on an analysis of the external data and the alertness of the occupant, and communicating the risk level and a suggestion to the occupant.

In an embodiment, a computer vision module is used to detect various aspects of the risk scenarios, occupant's body features, occupant's body posture, car seat configuration, and seat belt configuration. Vehicle interior sensing capabilities may include interior cameras and sensors that can be used to detect the presence of accessories such as seats, passengers, occupants' postures and movements, seat belt adjustments, airbags, and other safety systems accordingly. Advanced biometric sensors can identify individual passengers and customize the vehicle settings to their preferences, such as seat position. Advanced sensors and cameras can detect the presence of occupants in different seating positions within the vehicle. This information may be used to optimize safety features such as seat belt tension and adaptive restraints. Interior cameras are small cameras which may be strategically positioned within the vehicle to capture visual information. They may be used for various purposes, including child safety seat detection, occupant detection, gesture recognition, facial recognition, and monitoring the overall interior space.

In an embodiment, the sensing unit incorporates a gesture recognition component that determines whether a user's behavior corresponds to a predetermined operation input or an unintended posture change. By analyzing the pressure distribution data and recognizing specific gestures, the system performs control actions accordingly. This self-adaptive switching function ensures a convenient and personalized operation interface for the user while prioritizing driving safety and jerk prevention.

The cameras may utilize different technologies such as RGB (color) cameras, infrared cameras for night vision, or depth-sensing cameras for enhanced spatial understanding. Further, interior sensors are designed to detect and measure different parameters within the vehicle's interior. They can include pressure sensors, motion sensors, ambient light sensors, temperature sensors, humidity sensors, and air quality sensors, among others. These sensors provide data on occupant presence, seating positions, environmental conditions, and other relevant factors. The information captured by interior cameras and sensors is utilized by the vehicle's onboard systems and algorithms to enable risk assessment and threat level detection and whether the seat and/or seat belt needs adjustments. For instance, the data from interior cameras can be processed to detect the seat belt and check whether the seat belt is passing through designated locations or not. It may check using a computer vision module whether the seat belt is crooked or not. A vehicle's interior sensing system can provide feedback or alerts to the driver if it detects any issues with the seat belt, car seat or a seating position.

According to an embodiment of the system, the system comprises a computer vision module comprising a shape recognizing camera. According to an embodiment of the system, the processor is operable to capture, via a camera, an interior of the vehicle. According to an embodiment of the system, the information system comprises an infotainment system of the vehicle. According to an embodiment of the system, the system comprises a shape recognizing camera, wherein the shape recognizing camera comprises an image processing algorithm to identify and classify objects based on their shapes. According to an embodiment of the system, the child safety seat comprises weight sensors to determine the weight of the child. According to an embodiment of the system, the processor is operable to detect a position of a harness chest clip and guide for the optimal adjustment for accurate positioning.

The captured images or video frames are preprocessed to enhance image quality and reduce noise. This may involve operations such as resizing, noise reduction, and color normalization, etc. An object detection algorithm may be used for detecting various objects and various aspects of the objects. In an embodiment, a bounding box method may be used to extract various safety features. Computer vision algorithms are applied to detect objects within images. Specifically, the system focuses on identifying seat position, seat belt configuration, seating posture and body features. Object detection techniques like Haar cascades, convolutional neural networks (CNN), or other machine learning models can be used for this task. In an embodiment, risk assessment algorithms are executed. Once a potential threat/risk is detected, the system automatically adjusts or recommends a seating position and a seat belt configuration for the occupant.

Convolutional Neural Networks (CNNs) may be used in object detection tasks due to their ability to analyze visual data effectively. In the context of object detection, CNNs are trained using labeled datasets consisting of images and corresponding bounding box annotations. The CNN architecture includes layers for feature extraction, region proposal, and classification/localization. Initially, CNN extracts high-level features from input images, gradually learning more complex patterns. The region proposal network generates potential object bounding box proposals, and CNN classifies the proposed regions and refines the bounding box coordinates. Non-maximum suppression is applied to remove redundant detections. During inference, the trained CNN model processes new images to detect and localize objects, providing object labels and bounding box coordinates. CNNs enable accurate object detection by learning discriminative features and patterns, enhancing the performance of systems designed for object recognition and localization. A CNN architecture suitable for object detection is chosen. Popular architectures for object detection include Faster R-CNN, YOLO (You Only Look Once), and SSD (Single Shot MultiBox Detector). These architectures typically consist of convolutional layers for feature extraction, followed by region proposal or detection layers.

Based on the analysis of sensor data and image data, the system provides feedback or alerts to the driver or occupants. This feedback can be in the form of visual indicators on the vehicle's dashboard display or audible warnings to ensure that any issues with the child seat installation are addressed.

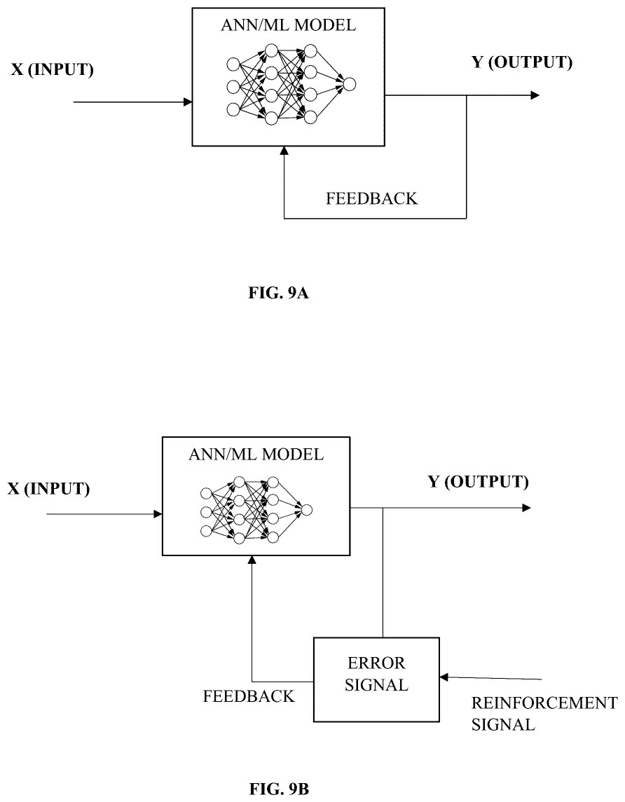

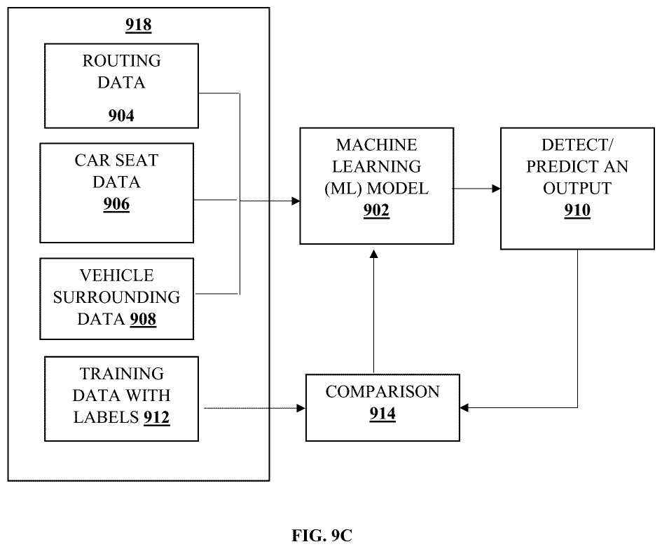

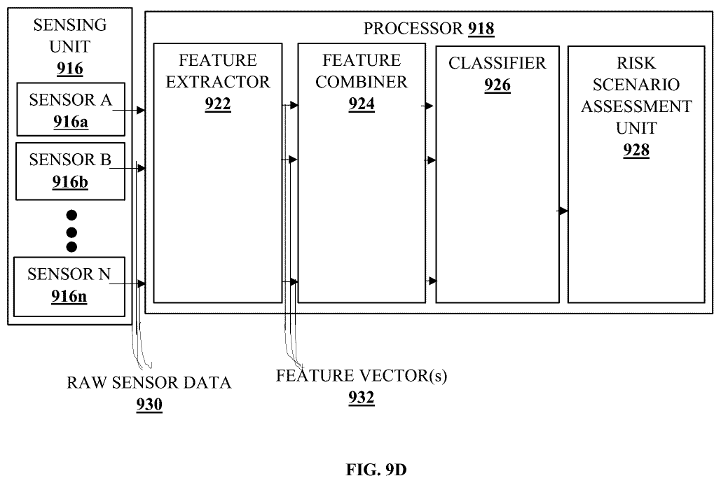

FIG. 9A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning may be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may predict or detect a risk and a risk level (the severity of the risk) based on the input data, such as target vehicle parameters, vehicle's surrounding parameters and occupant's alertness signals.

In an embodiment, ANN's may be a Deep-Neural Network (DNN), which is a multilayer tandem neural network comprising Artificial Neural Networks (ANN), Convolution Neural Networks (CNN) and Recurrent Neural Networks (RNN) that may recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labeled data and concepts, after a while the models' performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., alertness, risk level) are used that are meant for the model to learn. Afterward, the model is tested using unlabeled data. By using, for example, deep learning and neural networks, the model may then make predictions on whether the desired concept/s (e.g., risk is detected, an appropriate risk level is predicted, and seating position is predicted based on the risk level and alertness, etc.) are in unlabeled images. Each image is given a probability score where higher scores represent a higher level of confidence in the models' predictions. Where a model gives an image a high probability score, it is auto labeled with the predicted concept. However, in the cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system may improve its predictions in real-time and dynamically.

FIG. 9B shows a structure of the neural network/machine learning model with reinforcement learning. The network receives feedback from authorized networked environments. Though the system is similar to supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

FIG. 9C shows an example block diagram for detecting alertness and/or risk using a machine learning model. The machine learning model 902 may take as input any data associated with the occupant, the car seat and seat belt and learn to identify features within the data that are predictive of risk level and/or alertness. The training data sample may include, for example, the routing data 904. For example, through an application installed on the device, such as Google® maps and location services, the system may know the risk of jerks and possible impact to the occupant in the route.

In an embodiment, the training data sample may also include car seat data 906 including occupant's weight, height, and health. The systems and methods can identify alertness of an occupant in a vehicle and risk level of an impact to the occupant in real time using an on-board camera and/or other sensors. The alertness signals and risk related feature information, in real time, are transmitted to the cloud, where the risk level is coupled with available seat configuration and seat belt configuration in the case of a previously identified risk level and possible impact or jerk to the occupant. Subsequently, the information is used to compute/estimate a seat configuration and seat belt configuration. The systems and methods of the present disclosure may also provide data analytics information that may be used later to improve vehicle safety.

Real-time vehicles surrounding data 908 may include, for example, video, image, audio, infrared, temperature, 3D modeling, and any other suitable types of data that capture the current state around the vehicle. In an embodiment, the real-time sensor data may be processed using one or more machine learning models 902 trained and based on similar types of data to predict real-time features of the risk level. The real-time features may include, for example, traffic, neighboring vehicles' activities, weather condition, road condition, occupants alertness, etc. Current information about the target may be used for the estimation of seat configuration and seat belt configuration to avoid jerks and/or impact. For example, currently detected sensor data and/or previously known information about the road condition of a route may be used to predict a risk level and a seat configuration.

Any of the aforementioned types of data (e.g., routing data 904, car seat data 906, vehicle surrounding data 908, or any other data) may correlate with the risk level and the safe seat and/or seating position, and such correlation may be automatically learned by the machine learning model 902. In an embodiment, during training, the machine learning model 902 may process the training data sample (e.g., routing data 904, car seat data 906, vehicle surrounding data 908, or any other data) and, based on the current parameters of the machine learning model 902, detect or predict an output 910 which may be a collision probability and/or safe zone and collision zone. The detection or prediction of a collision probability and/or safe zone and collision zone may depend on the training data with labels 912 associated with the training data sample 918. Predicting a collision probability and/or safe zone and collision zone refers to predicting a future event based on past and present data and most commonly by analysis, estimation of trends or data patterns. Prediction or predictive analysis employs probability based on the data analyzes and processing. Detection of collision probability and/or safe zone and collision zone refers to an onset of the event and the system detecting the same. Predicted events may or may not turn into a collision based on how the turn of events occurs. In an embodiment, during training, the detected event at 910 and the training data with labels 912 may be compared at 914. For example, comparison 914 may be based on a loss function that measures a difference between the detected event 910 and the training data with labels 912. Based on the comparison at 914 or the corresponding output of the loss function, a training algorithm may update the parameters of the machine learning model 902, with the objective of minimizing the differences or loss between subsequent predictions or detections of the event 910 and the corresponding labels 912. By iteratively training in this manner, the machine learning model 902 may “learn” from the different training data samples and become better at detecting various collision events and risk levels at 910 that are similar to the ones represented by the training labels at 912. In an embodiment, the machine learning model 902 is trained using data which is specific to a type of target for which the model is used for detecting a collision to estimate high risk or low risk. In an embodiment, the machine learning model 902 is trained using data which is general to the vehicle types and is used for detecting a collision probability and thus determining a risk and a risk level.

Using the training data, a machine learning model 902 may be trained so that it recognizes features of input data that signify or correlate to certain event types. For example, a trained machine learning model 902 may recognize data features that signify the likelihood of an emergency situation, as an actionable event. Through training, the machine learning model 902 may learn to identify predictive and non-predictive features and apply the appropriate weights to the features to optimize the machine learning model's 902 predictive accuracy. In embodiments where supervised learning is used and each training data sample 918 has a label 912, the training algorithm may iteratively process each training data sample 918 (including routing data 904, car seat data 906, vehicle surrounding data 908, or any other data), and generate a prediction of jerk and/or collision event 910 based on the model's 902 current parameters. Based on the comparison 914 results, the training algorithm may adjust the model's 902 parameters/configurations (e.g., weights) accordingly to minimize the differences between the generated prediction of jerk and/or collision event 910 and the corresponding labels 912. Any suitable machine learning model and training algorithm may be used, including, e.g., neural networks, decision trees, clustering algorithms, and any other suitable machine learning techniques. Once trained, the machine learning model 902 may take input data associated with a vehicle, an occupant and output one or more predictions that indicate a jerk and/or collision event probability based on the real time data and may suggest/adjust a seat position and/or a seating position.

Sensor fusion is the process of combining data from multiple sensors to improve the accuracy, reliability, and efficiency of the information collected. It involves integrating information from multiple sources, such as cameras, radar, lidar, and other sensors, to obtain a more complete and more accurate picture of the environment. Sensor fusion may be able to reduce errors and uncertainties that may arise from using a single sensor and to obtain a more comprehensive understanding of the world around us. By combining data from multiple sensors, autonomous vehicle systems can make more informed decisions and respond to changing conditions in real-time. The process of sensor fusion typically involves several steps, including data acquisition, signal processing, feature extraction, data association, and estimation. Different algorithms and techniques may be used to integrate the information from multiple sensors, depending on the application and the specific sensors being used.

Referring to FIG. 9D, it shows neural network architecture for occupant alertness and risk assessment, according to an embodiment. The neural network architecture integrates sensing, feature extraction, feature combination, classification, and risk evaluation to analyze the surrounding data and ensure the safety and well-being of the vehicle's occupants. The sensing unit 916 is responsible for collecting data from various sensors (916a, 916b, . . . , 916n) installed in the vehicle, such as cameras, lidar, radar, and other environmental sensors. It captures information about the surroundings, including road conditions, other vehicles, pedestrians, and objects and sends them to the processor 918. The processor comprises a feature extractor 922, a feature combiner 924, a classifier 926, and risk scenario assessment unit 928. The feature extractor 922 processes the raw sensor data 930 obtained from the sensing unit 916 and extracts relevant feature vector(s) 932. It applies various techniques, such as image processing, signal processing, and data transformations, to convert the raw sensor data 930 into meaningful representations that can be used for further analysis. The feature combiner 924 combines the extracted features from multiple sources to create a comprehensive representation of the vehicle's surroundings. It integrates the information from various sensors and data modalities to provide a holistic view of the environment. This step ensures that the network considers multiple sources of information for accurate analysis and decision-making. The classifier 926 is a crucial component that takes the combined features as input and performs classification tasks. In the context of occupant alertness and risk assessment, the classifier is trained to recognize and classify different risk scenarios based on the surrounding data. It may identify hazardous situations, such as approaching vehicles too closely, pedestrians in the vehicle's path, or sudden changes in road conditions. The risk scenario assessment unit 928 receives the output of the classifier and evaluates the level of risk associated with each identified scenario. It combines the classification results with additional contextual information, such as the vehicle's speed, trajectory, and historical data, to assess the potential danger to the occupants. This component helps determine the severity of the risk and enables appropriate actions to be taken, such as issuing alerts or initiating preventive measures.

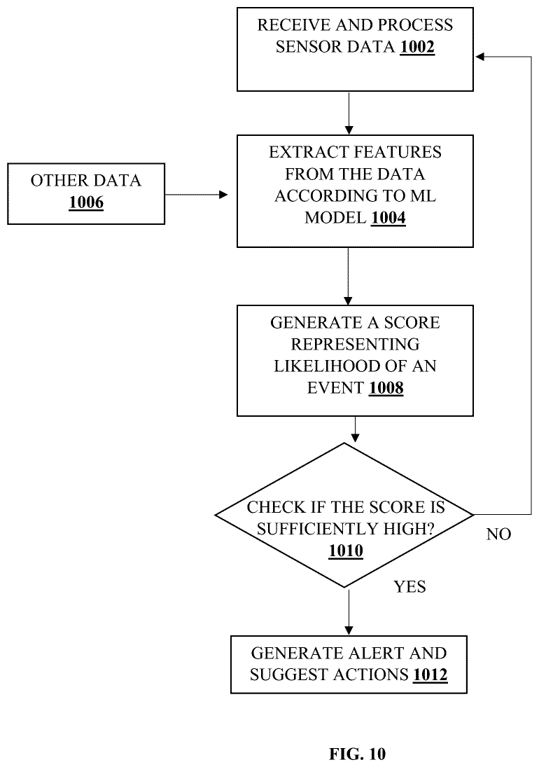

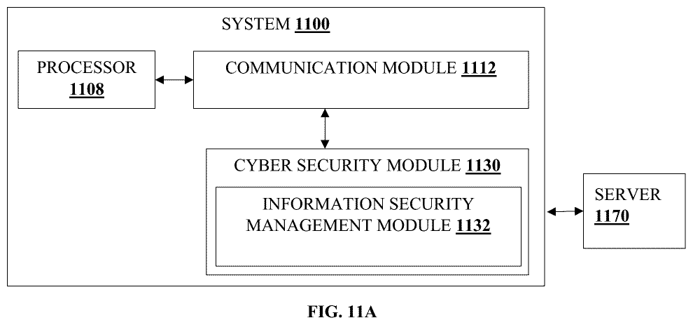

FIG. 10 shows an example flow chart for detecting a risk and a risk level with the vehicle's current location and occupant alertness using a machine learning model. The system may receive data associated with sensor output(s) from one or more sensors in the vehicle as shown at 1002. Any type of sensor may be used to gather data pertaining to the target vehicle. A sensor output may be, for example, images, videos, audios, LiDAR measures, infrared measures, temperature measures, GPS data, or any other information measured or detected by sensors. In an embodiment, a sensor output may be the result of a combination of one or more sensors capturing environmental information associated with the surroundings of the vehicle, which may include traffic at the location, curb margins, intersection details, etc. For example, sensor output may be associated with a passenger in the vehicle including the driver. In an embodiment, data associated with sensor output may include the raw sensor output (e.g., the images, videos, audios, etc.) and/or data derived from processing the sensor output. As an example, derivative data from image, video or LiDAR data may include data representing identified objects, motion, gestures, facial expressions, posture, eye position, etc. The system may receive any data associated with the sensor output from sensors, including raw sensory output and/or any derivative data. In an embodiment, the system may process the received data and identify any actionable event of interest using a machine learning model, trained using a set of training data. The system may also receive any other data as shown at 1006, wherein other data could be weather data, manual input, a broadcast message from other traffic related objects such as vehicle and infrastructure, etc.

As shown at 1004, the system may extract features from the received data according to a machine learning model. The machine learning model is able to automatically do so based on what it learned during the training process. In an embodiment, appropriate weights that were learned during the training process may be applied to the features.

At step 1008, the machine learning model, based on the features of the received data, may generate a score representing a likelihood or confidence that the received data is associated with a particular event type, e.g., a jerk due to a particular road condition or traffic condition, etc.

As shown at 1010, the system may determine whether the score is sufficiently high relative to a threshold or criteria to warrant certain action. If the score is not sufficiently high, thus indicating a false-positive, the system may return to step 1002 and continue to monitor subsequent incoming data. On the other hand, if the score is sufficiently high, then at step 1012 the system may generate an appropriate alert and/or determine an appropriate action/response. In an embodiment, the system may send alerts to appropriate recipients based on the detected event types. For instance, an automatic adjustment is made in the car seat and an alert is generated in the vehicle.

In an embodiment, the system may repeat one or more steps of the method of FIG. 10, where appropriate. In an embodiment, the steps 1002 to 1012 may be performed by the system, any combination of those steps may be performed by any other computing system, for example a remote network or a cloud network. In an embodiment, where machine learning models are used for making such determination, the system may transmit a trained machine learning model to the computing system in the vehicle to allow event-detection to occur locally. This may be desirable since sensor data may be overly large to transmit to the remote system in a timely fashion.

In an embodiment, the system is provided with the facial expression recognition module. It utilizes a Convolutional Neural Networks (CNN) pre-training process; and/or wherein the machine learning (ML) algorithm contains a bounding box procedure around the subject's face; and/or wherein the bounding box procedure utilizes a Viola-Jones detection algorithm; and/or wherein the face recognition module utilizes Facial Expression Recognition (FER) algorithms. In an embodiment, one or more currently obtained facial expressions from the camera are compared to thresholds for pre-trained emergency classifications to determine when a current classification is an emergency. The use of a recurrent neural network architecture comes from its ability to use past, temporal information for inference on current inputs. Long short-term memories (LSTMs) offer a computationally efficient way to train these networks. For example, video sequences of different vehicle types with their trajectory information at a turn may be used to train the LSTMs. By virtue of this training mechanism, the model may predict, given real time video input, when a collision is imminent given a host vehicle location. According to an embodiment of the system, the bounding box algorithm is used in conjunction with a machine learning algorithm for object detection, wherein the machine learning algorithm is a convolutional neural network (CNN).

In an embodiment, the system may comprise a cyber security module. In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message into a first data format associated with the vehicle environment and transmit the converted first data message to the communication module using a first communication protocol associated with the negotiated protocol.

According to an embodiment, secure authentication for data transmissions comprises, provisioning a hardware-based security engine (HSE) located in the cyber security module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the cyber security module with other computing system subjects (e.g., communication module) to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

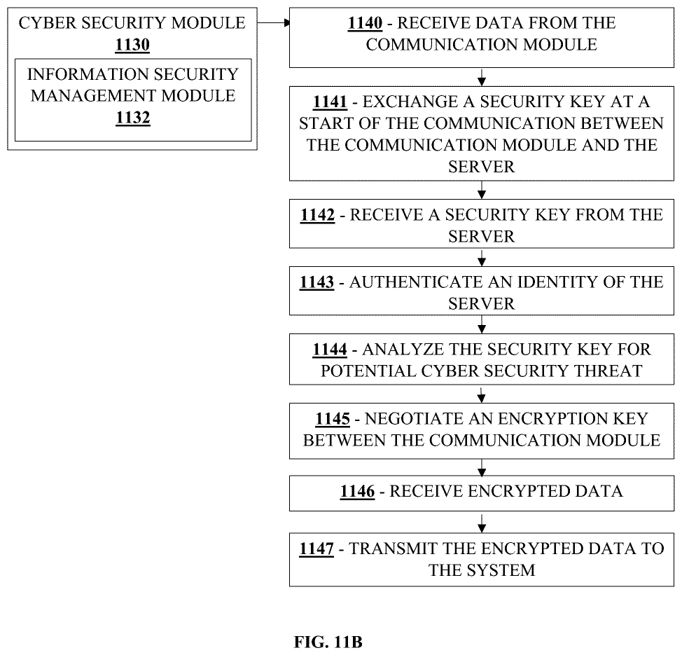

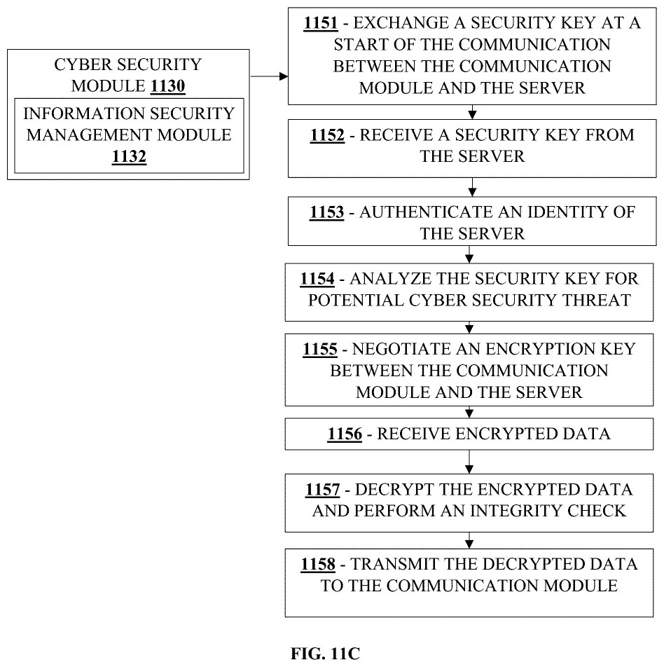

FIG. 11A shows the block diagram of the cyber security module. The communication of data between the system 1100 and the server 1170 through the communication module 1112 is first verified by the information security management module 1132 of cybersecurity module 1130 before being transmitted from the system to the server or from the server to the system. The information security management module is operable to analyze the data for potential cyber security threats, to encrypt the data when no cyber security threat is detected, and to transmit the data encrypted to the system or the server. System 1100 comprises a processor 1108.

In an embodiment, the cyber security module further comprises an information security management module providing isolation between the system and the server. FIG. 11B shows the flowchart of securing the data through the cyber security module 1130. At step 1140, the information security management module is operable to receive data from the communication module. At step 1141, the information security management module exchanges a security key at the start of the communication between the communication module and the server. At step 1142, the information security management module receives a security key from the server. At step 1143, the information security management module authenticates an identity of the server by verifying the security key. At step 1144, the information security management module analyzes the security key for potential cyber security threats. At step 1145, the information security management module negotiates an encryption key between the communication module and the server. At step 1146, the information security management module receives the encrypted data. At step 1147, the information security management module transmits the encrypted data to the server when no cyber security threat is detected.

In an embodiment, FIG. 11C shows the flowchart of securing the data through the cyber security module 1130. At step 1151, the information security management module is operable to: exchange a security key at the start of the communication between the communication module and the server. At step 1152, the information security management module receives a security key from the server. At step 1153, the information security management module authenticates an identity of the server by verifying the security key. At step 1154, the information security management module analyzes the security key for potential cyber security threats. At step 1155, the information security management module negotiates an encryption key between the communication module and the server. At step 1156, the information security management module receives encrypted data. At step 1157, the information security management module decrypts the encrypted data, and performs an integrity check of the decrypted data. At step 1158, the information security management module transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 11A, identity authentication is first conducted on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server conduct identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is conducted on the data after decryption, and if verification is passed, the data is sent out through the communication module; otherwise, the data is discarded. In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and may ensure that the safety of the data on the server cannot be compromised by a hacker attack under the condition of the Internet by ensuring the safety and reliability of the communication between the system and the server.

In some embodiments, the system enables automatic adjustment of vehicle seat settings based on occupant identification and location data. One or more sensors within the vehicle detect sensor data associated with occupant identification and location. The electronic control unit (ECU) communicates with a sensing unit and adjusts various vehicle settings to improve safety and convenience for the identified occupant. This occupant classification system enhances the overall driving experience and provides tailored comfort and safety features.

In some embodiments, the system incorporates an adaptive anti-jerk method that adjusts control parameters based on driving patterns derived from dynamic information and drivers' behaviors. By utilizing statistical analysis and neural networks, the system determines the appropriate driving pattern and adjusts seat and seat belt control parameters accordingly. This method enhances jerk avoidance capabilities by adapting to different driving speeds, road conditions, and driver habits.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-40. (canceled)

41. A system comprising:
an alertness detector unit configured to detect an alertness signal of an occupant;
an alertness determination unit configured to determine an alertness of the occupant based on the alertness signal;
a sensing module configured to sense external data in a route;
an analysis unit configured to analyze the external data to determine an external condition;
a risk assessment unit configured to determine in real-time a real-time risk level based on an analysis of the external data and the alertness of the occupant; and
a control unit configured to adjust a seat if determined that the real-time risk level was above a threshold.

42. The system of claim 41, wherein the alertness detector unit further comprises one or more of a seat adhered sensor, a vehicle adhered sensor, and a belt adhered sensor.

43. The system of claim 42, wherein the seat adhered sensor comprises a plurality of sensors, wherein the plurality of sensors comprises a seat belt sensor, a position sensor, a pressure sensor, a liquid detection sensor, a weight sensor, an infrared sensor, an optical sensor, a comfort detection sensor, a moisture sensor, a temperature sensor, an image sensor, a video sensor, and an audio sensor.

44. The system of claim 42, wherein the vehicle adhered sensor comprises a plurality of sensors, wherein the plurality of sensors comprises a seat belt sensor, a position sensor, a pressure sensor, a liquid detection sensor, a weight sensor, an infrared sensor, an optical sensor, a comfort detection sensor, a moisture sensor, a temperature sensor, an image sensor, a video sensor, and an audio sensor.

45. The system of claim 42, wherein the belt adhered sensor comprises a plurality of sensors, wherein the plurality of sensors comprises a position sensor, a pressure sensor, a liquid detection sensor, a weight sensor, an infrared sensor, an optical sensor, a comfort detection sensor, a moisture sensor, a temperature sensor, an image sensor, a video sensor, and an audio sensor.

46. The system of claim 41, wherein the occupant is one or more of a driver and a passenger in a vehicle.

47. The system of claim 41, wherein the alertness determination unit comprises a computer vision module.

48. The system of claim 47, wherein the computer vision module analyzes an image to determine alertness of the occupant.

49. The system of claim 41, wherein the alertness signal comprises one or more of a seating position, a body posture, a head position, a head angle, a head tilt, and an eye gaze position.

50. The system of claim 41, wherein the external data comprises one or more of speedometer data, Global Positioning System (GPS) data, road condition data, traffic data, vehicle-to-vehicle (V2V) data, vehicle-to-infrastructure (V2I) data, weather information, and pre-crash information.

51. The system of claim 41, wherein the control unit is further configured to restrict a seat adjustment function based on the real-time risk level.

52. The system of claim 51, wherein the seat adjustment function comprises one or more of a seat recline, a seat height, a seat belt payout, a backrest angle, a lumbar support adjustment, a seat belt tightness, a seat belt adjustment, and a seat belt travel length.

53. The system of claim 52, wherein the control unit adjusts the seat adjustment function based on height, weight, and size of the occupant.

54. The system of claim 41, further comprises:
a routing unit configured to generate the route to be pursued by a vehicle;
a prediction unit configured to predict an upcoming road condition; and
a recommendation unit configured to provide a recommendation for a suitable seating position based on the upcoming road condition.

55. The system of claim 54, wherein the recommendation unit is further configured to provide an updated recommendation for the suitable seating position based on the real-time risk level.

56. The system of claim 41, wherein the external condition is one or more of a weather condition, a lane reduction, a traffic condition, a winding route, an icy road, a neighboring car, a sloped road, and a road turn.

57. A method comprising:
detecting an alertness signal of an occupant in a vehicle;
determining an alertness of the occupant based on the alertness signal;
sensing external data;
determining a risk level based on an analysis of the external data and the alertness of the occupant; and
adjusting a seat if determined that the real-time risk level was above a threshold.

58. The method of claim 57 further comprising:
generating a route to be pursued by the vehicle;
predicting an upcoming road condition; and
providing recommendation for a suitable seating position based on the upcoming road condition.

59. The method of claim 58, wherein the method further comprises providing an updated recommendation for the suitable seating position based on the risk level in real-time.

60. A non-transitory computer-readable medium having stored thereon instructions executable by a computer system to perform operations comprising:
detecting an alertness signal of an occupant in a vehicle;
determining an alertness of the occupant based on the alertness signal;
sensing external data;
determining a risk level based on an analysis of the external data and the alertness of the occupant; and
adjusting a seat if determined that the real-time risk level was above a threshold.
